(19) United States
(12) Patent Application Publication
(10) Pub. No.: US 2020/0130770 A1
(43) Pub. Date: Apr. 30, 2020

(54) Materials and Construction for High-Strength, Light-Weight Bicycle

(71) Applicant: ATOMICA, Stafford, TX (US)

(72) Inventors: Ting Chen, Missouri City, TX (US); Ram Shenoy, Katy, TX (US); Indranil Roy, Missouri City, TX (US)

(73) Assignee: ATOMICA

(21) Appl. No.: 16/175,724

(22) Filed: Oct. 30, 2018

(51) Int. Cl. B62K 19/06; B22F 5/10; C22C 21/18

(52) U.S. Cl. CPC B62K 19/06; B22F 5/106; C22C 1/0416; B22F 2998/10; B22F 2999/00; C22C 21/18

(57) ABSTRACT

Systems and methods for fabricating a high-strength, low-weight material suitable for construction of a bicycle. A composition of powdered materials including magnesium, aluminum, copper, zinc, zirconia, and silicon carbide is combined and blended together. The mixture is vacuum hot pressed into a billet and then extruded. The resulting material is suitable for construction of a bicycle having excellent physical properties including strength, flexibility, comfort, and light-weight.

### BACKGROUND

Bicycles have been made of a variety of different materials over the years, from wood to steel to aluminum and carbon fiber. Magnesium and its alloys, a reactive metal system that is difficult to weld, is extruded by very few companies worldwide and is forged by even fewer. Magnesium weld rod is only available from a very small number of makers and has not been met with commercial success as an alloy for bicycles. Magnesium also generally has a 30% lower modulus which adds to the list of challenges. In contrast, Aluminum needed a minimum of 8 to 10 years to become commonplace as a bicycle alloy, considering it is non corrosive in most environments, can retain polish, can be easily anodized, painted and extruded by no less than 300 firms world-wide.

Simple changes in geometry in the tubes used in bicycles for example can make a big difference. Many bicycle producers believe that 1 ¾″ Mg alloys will be too stiff, but they fail to understand that the lower modulus of elasticity (30% lower) will retain a soft feel. Overcoming consumer's lack of education by factual demonstration can help to promote Mg usage in bicycles.

In a carbon fiber composite structure, reinforcing fiber—the carbon—is encased in the matrix material, an epoxy resin. Carbon composites derive most of their strength from the carbon filaments, but those filaments are nothing without the resin that binds them together. A major factor in high quality carbon composite bicycles becoming a reality has been the advancements in the manufacture of both carbon filaments and resins over the past decade. Some carbon fiber materials have a modulus of elasticity between 200-600 GPa and a tensile strength of between 2,500-3,500 MPa.

In terms of carbon filaments, one important factor has been the ability to tailor fibers of high tensile strength of around 600 to 700 ksi (thousand pounds per square inch). Fiber filaments are also rated by their modulus (stiffness) and can be referred to as either being standard, intermediate, or high modulus fiber. The strength and stiffness of carbon filament does not always correlate with each other. Unfortunately fiber higher than intermediate modulus tend to get weaker as they get stiffer. As a result, the design of a composite structure has to balance these two attributes in order to optimize the performance and durability of the finished product.

It is to be appreciated that the filaments are nothing without the resin, and the key to a good resin job is to get it evenly compacted in just the right ratio with the carbon. With shapes as complicated as are found in modern composite structures it is easy appreciate how some areas may not get fully compacted. Those regions can lead to filament separation and failure. Depending on the area and compaction needed, foam shells, carbon shells, alongside pressure intensifiers to squeeze the composite just right are often employed.

For bicycles, most frame manufacturers use continuous sheet of filaments “pre-impregnated” (pre-preg) with uncured resin as the building block. The pre-preg is adhered to a carrier sheet, or backing paper, so that it can be more easily handled. Properly handled sheets are stored in freezers to keep the resin from curing prematurely, and in production the sheets are cut and layered up in climate controlled rooms.

To give bike frames their structural strength manufacturers employ a variety of unidirectional carbon fiber pre-preg sheets, or “plies”. Each ply is designated by the fiber orientation as being either a 0°, a plus 45°, a minus 45°, and/or a plus or minus 30°. Each orientation bestows a different mechanical attribute to the structure. 0° sheets build strength and stiffness along the length of the structure. Plus and minus 30° sheets resist twisting, and the 45° 's fend off crushing loads. Together they determine the strength and stiffness characteristics of our little mechanical structure. There can be hundreds of individual sheets of pre-preg in a single frame, each one a unique shape that goes into a predetermined location in the layup.

Composite frames are molded using layers of pre-preg in a very specific sequence and orientation. The combination of heat and pressure first causes the resin in the pre-preg to flow, compacting the laminate and fusing the plies together as the excess resin gets pressed out of the structure. As the temperature increases, the epoxy hardens by way of a non-reversible chemical reaction. When fully cured the separate pre-preg components integrate with each other into a continuous structure.

A critical aspect of composite manufacturing is the skill of the workers actually laying up the pre-preg according to the lay-up schedule and the quality controls built into the manufacturing process. This is to ensure that every frame meets the strength, stiffness and weight goals for that design. These factors add up and make a good carbon composite frame very expensive. Also, a crash can totally destroy the carbon frame.

Magnesium (Mg) bikes have existed since the 1980s, when Frank Kirk made the first cast magnesium bike frames while working at Ford in Dagenham, England. Oscar Pereiro won the 2006 Tour de France on Pinarello's Dogma FPX magnesium bicycle. The Dogma FPX offers triple butted Mg alloy frame. It features an ONDA FPX fork utilizing a 1¼″ bearing at the fork crown and a 1⅛″ at the top of the headset. Magnesium offers elongation in the 10% range, which helps make a durable frame with low notch memory for high impact and dent resistance. Magnesium can be used to engineer bike frames that are lighter than aluminum while maintaining high tensile strength and damping capabilities. All of that leads to a much smoother, more efficient ride. Magnesium also comes in at a lower price point than popular lightweight materials like carbon fiber.

Though these bikes made an appearance in the Tour de France, they could not succeed commercially due to manufacturing and build quality issues. Of late, DT Swiss, Paketa Cycles and others are addressing the challenges of magnesium bike frames through new technologies and the creation of new alloys. These developments are designed to yield better bikes that take advantage of the lightness, stiffness and high damping capacity of magnesium.

### SUMMARY

The present disclosure is directed to a novel Mg alloy frame for designing ATOMICA's (™) bicycle. Based on experience in designing novel alloys and metal matrix composites stemming from Mg as matrix with second phase for tailoring stiffness and minor alloying elements for strengthening and reducing corrosion resistance, the subject material of the present disclosure has resulted in a riding product like no other.

Embodiments of the present disclosure are directed to a design methodology to engineer a light-weight, high-strength alloy and extrude tubes with a form factor for bicycle frames with features such as internal fins offering adequate stiffness, thus riding comfort is obtained without compromising superior performance. The materials of construction are of Mg alloy matrix and will be resistant to environmental corrosion and will be weld-able using common Mg alloy electrodes. Last but not least, the alloy can be produced by different routes for added performance and tailored to meet cost targets. Various features of the present disclosure are described herein.

### BRIEF DESCRIPTION OF THE FIGURES

FIG. 1 is a graph of a binary Al—Mg phase diagram according to embodiments of the present disclosure.

FIG. 2 is a binary Mg—Zn phase diagram according to embodiments of the present disclosure.

FIG. 3 is a binary Al—Zn phase diagram according to embodiments of the present disclosure.

FIG. 4 is a ternary Al—Mg—Zn phase diagram according to embodiments of the present disclosure.

FIG. 5 is a first-melting projection (FMP) of the phase diagram of the Zn+Mg+Al system shown in FIG. 4 according to embodiments of the present disclosure.

FIG. 6 is a flowchart diagram showing methods according to the present disclosure by which a material having the desired properties can be manufactured.

FIG. 7 is a Differential scanning calorimetry (DSC) scan on a cold pressed billet to predict temperature ranges for solid state reactions and incipient melting in blends from Exotherms and Endotherms to converge on consolidation temperatures according to embodiments of the present disclosure.

FIG. 8A is a front cross-sectional illustration of an extrusion process according to embodiments of the present disclosure.

FIG. 8B is a side cross-sectional view of the embodiments of FIG. 8A according to embodiments of the present disclosure.

FIG. 9 is a cross-sectional view of the resulting tube structure formed according to the fabrication and extrusion systems and methods of the present disclosure.

### DETAILED DESCRIPTION

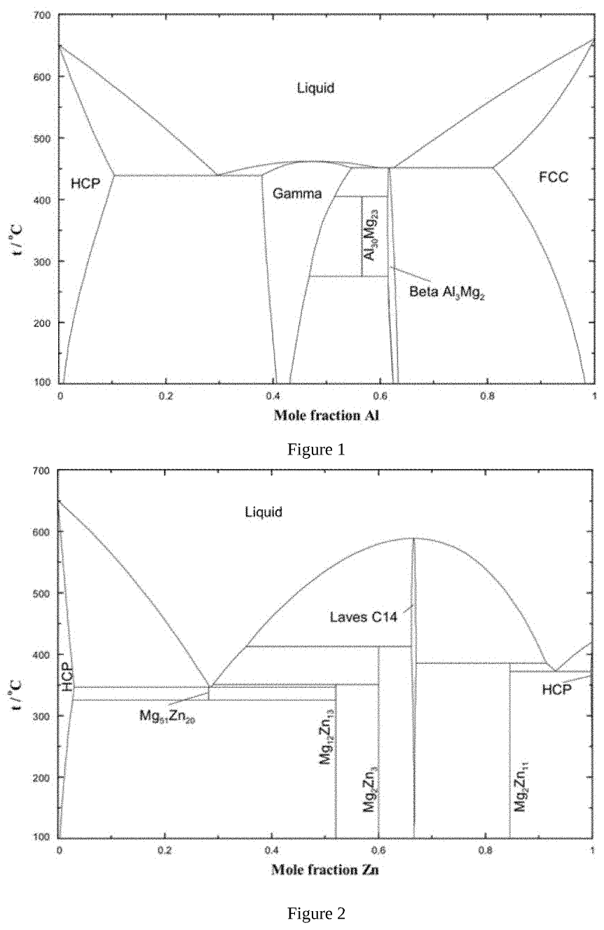

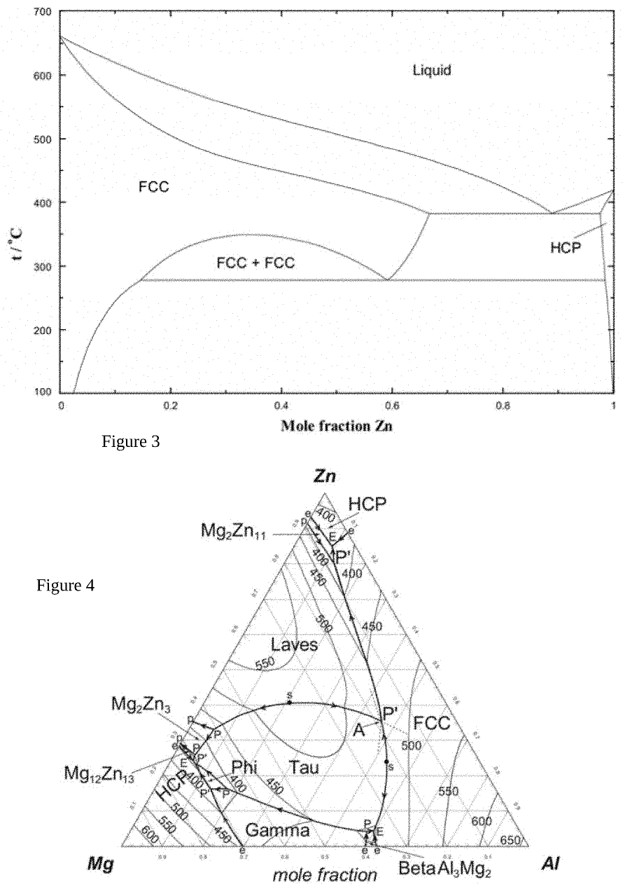

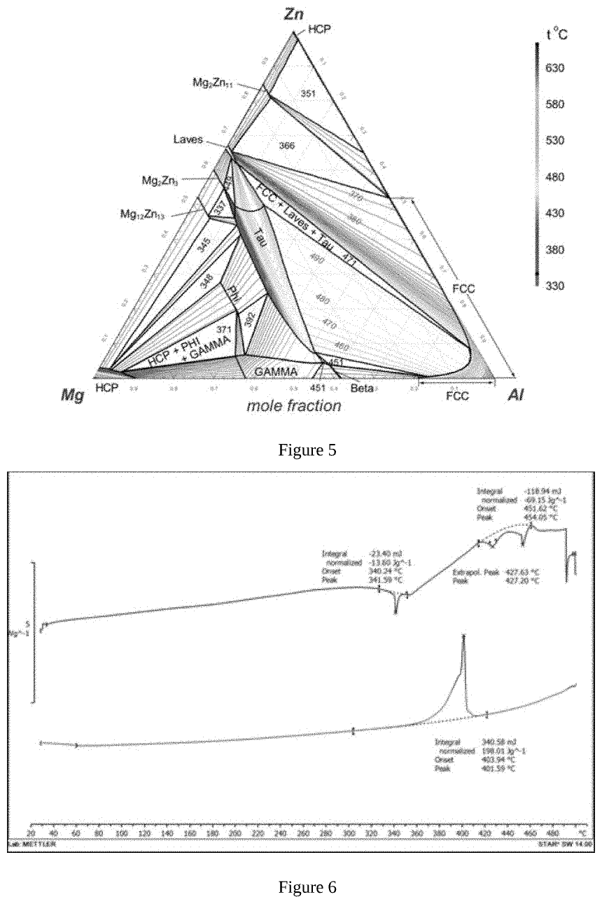

Below is a detailed description according to various embodiments of the present disclosure. FIG. 1 is a graph of a binary Al—Mg phase diagram according to embodiments of the present disclosure. FIG. 2 is a binary Mg—Zn phase diagram according to embodiments of the present disclosure. FIG. 3 is a binary Al—Zn phase diagram according to embodiments of the present disclosure. FIG. 4 is a ternary Al—Mg—Zn phase diagram according to embodiments of the present disclosure. FIG. 5 is a first-melting projection (FMP) of the phase diagram of the Zn+Mg+Al system shown in FIG. 4 according to embodiments of the present disclosure.

The first-melting projections (FMP) from phase diagrams, be it a binary, ternary or a higher-order system, predicts the temperature at which there is the first emergence of a liquid phase upon heating at any given composition at thermodynamic equilibrium. Generally, FMP are identical to solidus projections. They are often observed to obey same established topological rules as isothermal sections of phase diagrams. Only in systems with metatectic (catatectic) invariants (partial melting during cooling) or retrograde solid solubility do exceptions to these rules occur. In these regions the FMP and solidus projections are not identical. Here we usually plot the FMP which is always single-valued at all compositions.

The liquid projection of the (Zn+Mg+Al) system is shown in FIG. 4. The phase diagrams of the (Mg+Al, Mg+Zn, and Al+Zn) binary sub-systems are shown in FIGS. 1, 2, and 3. These diagrams have been calculated by minimization of Gibbs energy minimization with a commercial software. The calculated FMP for the ternary system is shown in FIG. 5. For each ternary eutectic point (E), ternary peritectic point (P) and ternary quasi-peritectic point (PAT) on the liquid projection in FIG. 4, there is a corresponding isothermal tie-triangle on the FMP, each labeled with the temperature of the invariant reaction (FIG. 5). This ternary alloy will first melt isothermally (peritectically in this case) at 471° C. to form a liquid phase with a composition at the peritectic point labelled A in FIG. 4.

Initial phase behavior is determined by simulation and predictions after production of binary and ternary phase diagrams using simulation software, for example “Thermocalc”, “FactSage” etc. Eutectic and peritectic reactions in designed alloys dictates design by PM or IM processing. Simulation predicts temperature range to consolidate blended powders (PM route) or alternatively melting temperature (IM route).

FIG. 6 is a flowchart diagram showing methods according to the present disclosure by which a material having the desired properties can be manufactured. At 100 powdered materials are mixed together in a homogeneous manner to promote an even mix of the materials. According to embodiments the materials are:

| Material | % by weight |
|---|---|
| Aluminum (Al) | 25 ± 5% |
| Zinc (Zn) | 8 ± 2% |
| Copper (Cu) | 1.5 ± 1% |
| Zirconia (Zr) | 0.5 ± 0.4% |
| Silicon Carbide (SiC) | 0.5-10% |
| Magnesium (Mg) | Remainder |

The portion of Mg of course is calculated after the other constituents have been chosen and will complete the 100%.

The materials are in powdered form which helps to promote an even blend. Each of these materials can be obtained in a powdered form using known techniques. At 102 the materials are blended together. In some embodiments the blending can be achieved by using a V-blending technique. The materials can be blended in such a way that segregation between the powders is minimized or eliminated. At 104 the mixture can be vacuum hot pressed at a temperature of 750 degrees F., ±25 degrees F. The vacuum hot pressing causes the materials to melt and fuse together and when it cools it forms a solid alloy that can be extruded or otherwise machined. At 106 the material is extruded. In some embodiments the extrusion can be performed using a die-mandrel-container configuration with the billet at 800 degrees F., the die at 700 degrees F., the mandrel at 800 degrees F., and the liner/container at 800 degrees F. The shape of the die and mandrel can form the desired shape of the tubes which can be constructed into a bicycle frame.

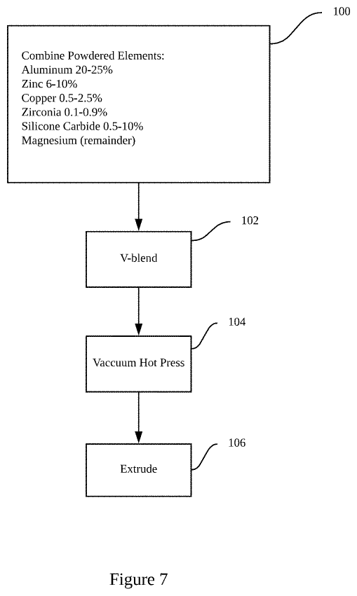

FIG. 7 is a Differential scanning calorimetry (DSC) scan on a cold pressed billet to predict temperature ranges for solid state reactions and incipient melting in blends from Exotherms and Endotherms to converge on consolidation temperatures according to embodiments of the present disclosure.

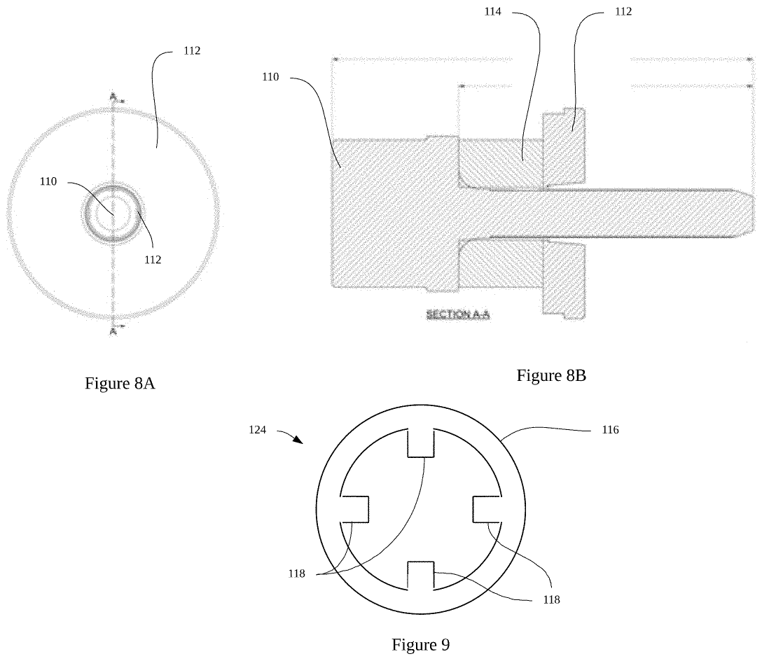

FIG. 8A is a front cross-sectional illustration of an extrusion process according to embodiments of the present disclosure. FIG. 8B is a side cross-sectional view of the embodiments of FIG. 8A according to embodiments of the present disclosure. The material produced by the methods and systems discussed and described previously can be machined in a variety of ways including milling, welding, and cutting. The extrusion process shown and described in FIGS. 8A and 8B involve the use of a mandrel 110 and a die 112. The billet 114 is O-shaped and is placed on the mandrel 112 which urges the billet against the die 112. The die 112 has a shape that defines the resulting extruded shape of the material. In this case, the material will be extruded into hollow tubes suitable for use in manufacturing a bicycle or other similar activities. The extrusion process can be executed with the billet at 800 degrees F., with the die at 700 degrees F., the mandrel at 800 degrees F., and a liner/container also at 800 degrees F. All temperatures can be ±10 degrees F. The liner/container is not shown but it can be configured and positioned to receive the extruded tube.

FIG. 9 is a cross-sectional view of a resulting tube structure 124 according to embodiments of the present disclosure. In some embodiments the die 112 has an interior profile that produces fins 118 on an interior surface of the tube. The thickness of the tube walls at 116 can be 40 mils ( 40/1000″) or approximately 1 mm. The fins 118 can be approximately twice as thick as the walls at 80 mils (approximately 2 mm). Other dimensions are possible. In other embodiments the thickness is not uniform and the tube can be elliptical, square, rectangular, or polygonal. The fins extend along the length of the tube and give additional stiffness to the tubes especially when subject to bending loads similar to the loads experienced in a bicycle. In the embodiment shown there are four fins distributed around the perimeter of the tube in each cardinal direction. In other embodiments there may be more than four fins. The width of the fins can be approximately 2 mm but wider fins are also possible. The wider and thicker the fins, the stiffer the resulting tube will be. The stiffness of the tube can accordingly be tailored closely by manipulating the size of the fins.

The foregoing disclosure hereby enables a person of ordinary skill in the art to make and use the disclosed systems without undue experimentation. Certain examples are given to for purposes of explanation and are not given in a limiting manner.

1. A method of fabricating a material for a bicycle, the method comprising:
combining powdered aluminum (Al), powdered zinc (Zn), powdered copper (Cu), powdered zirconia (Zr), powdered silicon carbide (SiC), and powdered magnesium (Mg) in the following percentages by weight: Al (20-30%) Zn 6-10%, Cu (0.5-2.5%), Zr (0.1-0.9%), SiC 0.5-10%, and Mg (remainder);
blending the powdered constituents in a manner to substantially eliminate segregation;
vacuum hot pressing the mixture at 750 degrees F.; and
extruding the resulting billet into a tube shape.

2. The method of claim 1 wherein vacuum hot pressing the mixture is performed between 725 degrees F. and 775 degrees F.

3. The method of claim 1 wherein extruding the resulting billet is performed with the billet at 750 degrees F.

4. The method of claim 1 wherein extruding the resulting billet is performed using a mandrel and a die with the mandrel at 800 degrees F., the die at 700 degrees F., the mandrel ad 800 degrees F.

5. The method of claim 4 wherein the mandrel is between 790 and 810 degrees F., the die is between 690 and 710 degrees F., and the billet is between 740 and 760 degrees F.

6. The method of claim 4 wherein extruding the resulting billet comprises forming fins on an interior surface of a tube.

7. The method of claim 6 wherein the fins are approximately twice as thick as the walls of the tube.

8. The method of claim 4 wherein forming fins on the interior surface of the tube comprises forming four generally-equally spaced fins at approximately 90 degrees from one another.

9. The method of claim 1 wherein extruding the resulting billet into a tube shape comprises forming a tube with walls of approximately 1 mm thickness.

10. The method of claim 1 wherein blending the powdered constituents comprises V-blending the powdered constituents.

11. The method of claim 1 wherein extruding the resulting billet comprises extruding at an extrusion ratio of 30:1.

12. The method of claim 12 wherein after extrusion the tube shape has a specific gravity of between 2 and 2.6 and a strength of between 40 and 80 ksi.

13. A bicycle, comprising:
a frame having hollow tube sections, the hollow tube sections having interior fins being approximately twice as thick as walls of the tube sections, the fins running substantially the length of the tube sections, wherein the frame is extruded from a combination of 20-25% aluminum, 6-10% zinc, 0.5-2.5% copper 0.1-0.9% zirconia, 0.5-10% silicon carbide, and the remainder magnesium.

14. The bicycle of claim 13 wherein the aluminum, zinc, copper, zirconia, silicon carbide, and magnesium are combined in powdered form, blended, and vacuum hot pressed into a solid billet before extruding.

15. The bicycle of claim 13 wherein the frame comprises a top tube, a head tube, a down tube, a bottom bracket shell, and a seat tube, and wherein the top tube, head tube, down tube, bottom bracket shell, and seat tube are extruded according to claim X.

16. The bicycle of claim 13 wherein the frame is extruded at an extrusion ratio of 30:1.

17. A material, comprising a mix of constituents of 25% aluminum, 8% zinc, 1.5% copper, 0.5% zirconia, 5% silicon carbide, and 60% magnesium, wherein the constituents are mixed together in powdered form in a manner to substantially prevent segregation between the constituents, wherein the constituents are vacuum hot pressed at 750 degrees F.

18. The material of claim 17 wherein the material is extruded into a tube shape having interior fins extending along an interior surface of the tube, wherein the fins are approximately twice as thick as walls of the tube.

19. The material of claim 17 wherein the material has a specific gravity of between 2 and 2.6.

20. The material of claim 17 wherein the material has a strength of between 40 and 80 ksi.
